(19) United States
(12) Patent Application Publication
(10) Pub. No.: US 2004/0199487 A1
(43) Pub. Date: Oct. 7, 2004

(54) Data storage and retrieval systems

(76) Inventor: Andrew John Eio, Wokingham Berkshire (GB)

Correspondence Address: William M Lee, Barnes & Thornburg, P O Box 2786, Chicago, IL, 60690-2786, US

(21) Appl. No.: 10/485,081

(22) PCT Filed: Jul. 24, 2002
(86) PCT No.: PCT/GB02/03392

(30) Foreign Application Priority Data
Jul. 25, 2001 (GB) 0118127.0

(51) Int. Cl. G06F 7/00

(52) U.S. Cl. 707/1

(57) ABSTRACT

A database server (2) stores a large number of electronic assets—for example, images, documents, video streams, audio data and so on. An application server (3) stores, for each of a plurality of products, a plurality of product parameters, one of which is a subset of the electronic assets in the database server (2). Another parameter for each product is a release date. A web server (1) allows visitors to log onto the database server (2). The application server (3) stores parameters for visitors, including lead times, and makes available to a given visitor all assets that are relevant to that visitor and have not yet reached their release date and are within the visitor's lead time. This is convenient for the visitor, who does not have to filter out irrelevant data. Moreover, the amount of traffic passing over the system is thus significantly reduced, thereby improving efficiency and operating speed of the system and reducing the likelihood of blockages.

This invention relates to data storage and retrieval systems.

Data storage and retrieval systems exist in very many different forms. At the present time, they are capable of storing very large amounts of data. This can often be accessed by very many users, especially when disseminated over a network, of which the Internet is an example.

Due to the large amount of data that can be stored and the large number of users that may wish to access it, problems can arise in providing efficient access to the data.

At the present time, the advertising industry has a very wide range of differing types of media at its disposal. Such differing kinds of media can have very differing requirements, not only as to the types of data that it uses, but also the lead time required to receive such data and produce an output.

If a company wishes to launch a new product and provide press releases through various advertising channels, a traditional printed publication editor may require a lead time of a month to publish an article on a new product, whereas an editor of a web-based (Internet) publication may require only a couple of days.

This can provide a very complicated logistical exercise, for a company to manage all of its press release material for different dates and for different types of media—not to mention yet further added variations such as differing requirements for differing countries.

Preferred embodiments of the present invention aim to provide data storage and retrieval systems that maybe improved in the foregoing respects.

According to one aspect of the present invention, there is provided a data storage and retrieval system comprising:

a first database arranged to store a plurality of electronic assets;

a second database arranged to store a plurality of product parameters for each of a plurality of products;

a third database arranged to store a plurality of visitor parameters for each of a plurality of visitors; and

a controller arranged to control retrieval of said assets in dependence upon said parameters:

wherein:

one of said product parameters for each of said products comprises a subset of said electronic assets which is associated with the product;

another of said product parameters for each of said products comprises a release date;

one of said visitor parameters for each of said visitors comprises a lead time; and

said controller is arranged to permit retrieval of said assets by a visitor over a real time period that commences upon a date that is equal to said release date of one of said products minus said lead time of the visitor.

According to another aspect of the present invention, there is provided a method of storing and retrieving data, comprising the steps of:

storing a plurality of electronic assets in a first database;

storing in a second database a plurality of product parameters for each of a plurality of products;

storing in a third database a plurality of visitor parameters for each of a plurality of visitors; and

controlling retrieval of said assets in dependence upon said parameters:

wherein

one of said product parameters for each of said products comprises a subset of said electronic assets which is associated with the product;

another of said product parameters for each of said products comprises a release date;

one of said visitor parameters for each of said visitors comprises a lead time; and

said controller permits retrieval of said assets by a visitor over a real time period that commences upon a date that is equal to said release date of one of said products minus said lead time of the visitor.

Said first, second and third databases may be located in a common memory device.

A system as above may further comprise archive means which is arranged to archive each of said assets after the release date of the or each said product with which it is associated has passed.

A system as above may further comprise a network server that is arranged to provide access to said assets to visitors over a network

Said network may be a global computer network—for example, the Internet.

At least one of said electronic assets may be selected from images, documents, video streams and audio data.

One of said product parameters may comprise territory.

At least one of said visitor parameters may be selected from territory, media type and operating platform.

Preferably, update means is provided and is arranged to update a common parameter of a plurality of said assets upon updating a like parameter for one of said products with which said assets are associated.

The invention extends to a computer program on a carrier and adapted to perform a method according to any of the preceding aspects of the invention.

A computer when programmed to perform a method according to any of the preceding aspects of the invention.

For a better understanding of the invention, and to show how embodiments of the same may be carried into effect, reference will now be made, by way of example, to the accompanying diagrammatic drawings, in which:

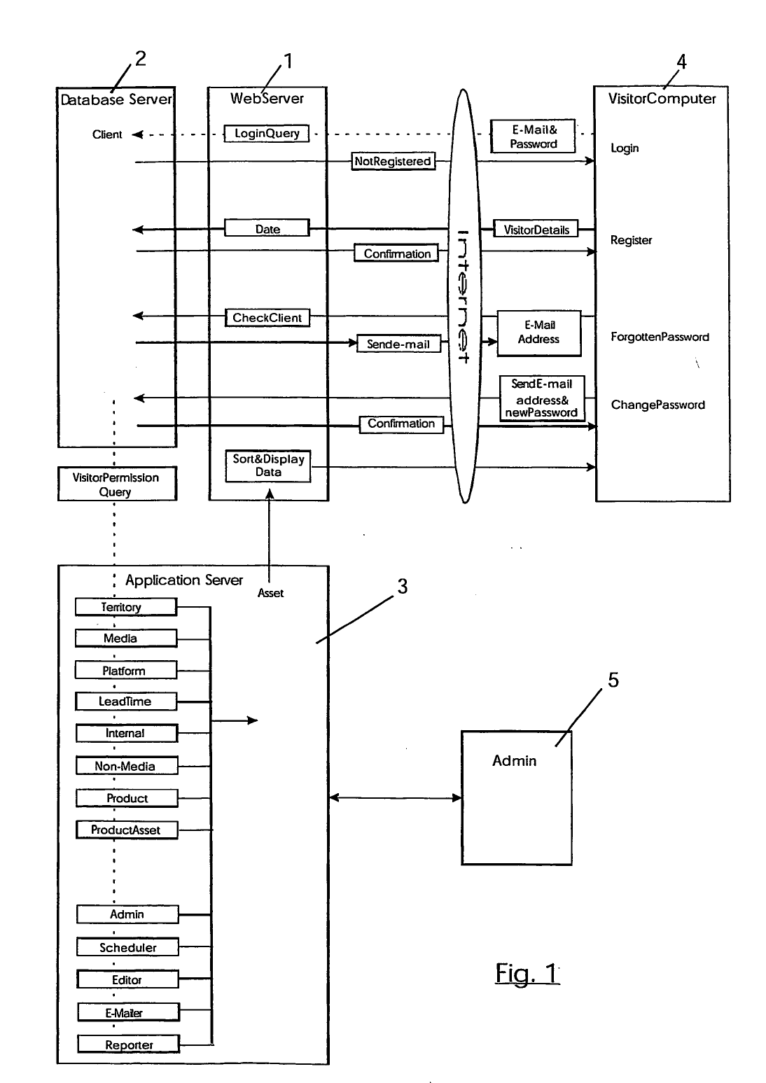

FIG. 1 is a schematic diagram of one example of a data storage and retrieval system comprising a preferred embodiment of the invention; and

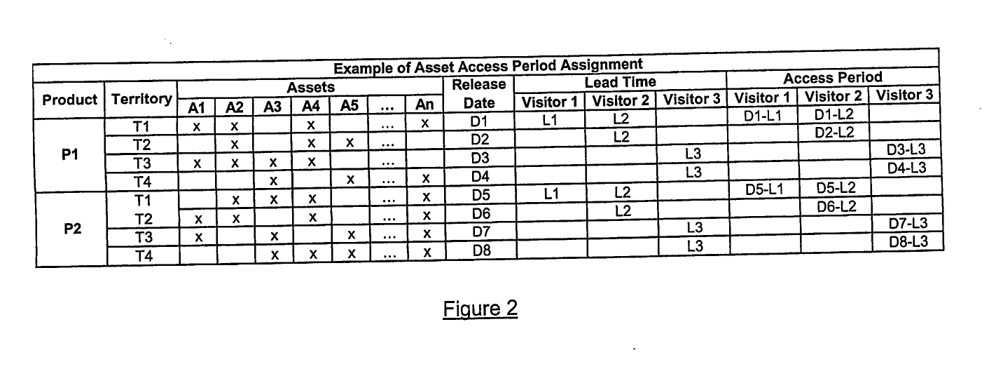

FIG. 2 is a chart to illustrate a simplified example of an assignment of access periods to electronic assets.

The illustrated data storage and retrieval system is Internet-based. It comprises a web server 1, a database server 2 and an application server 3. All three servers may be provided at a common location, or spread over different locations that are distributed over the Internet.

The system provides access to data for a plurality of visitors, and a single example of a visitor computer 4 is shown although, in practice, there will be very many visitors. An administrator has access to the application server 3 via an administrator computer 5. This may be by direct access as shown or, alternatively or additionally, by access over the Internet. There may be a plurality of Administrators.

The database server 2 provides a first database that stores a large number of electronic assets. For the purposes of this specification, the term “electronic asset” means information represented electronically, and this includes all digital formats. For example, in the context of the present example, the assets may comprise images, documents, video streams, audio data and so on.

The various electronic assets are associated with various different products. The application server 3 provides a second database that stores a plurality of product parameters for each of the products. One such parameter for each product is a subset of the electronic assets that are associated with the product. That is, each product will have a number of assets associated with it, and the application server 3 has a note of those assets.

Another parameter that is stored for each of the products is a release date. This is the date (usually, simply, a particular day, although more precise information such as exact time could be included) upon which the product is due for release.

A further parameter that may be associated with each product is territory. For example, a given product is likely to have a different subset of assets for different countries.

Other parameters may be associated with each product.

The application server 3 also provides a third database that stores parameters for each visitor. A common parameter for each such visitor is the value “lead time”. In the context of the present example, this represents the lead time that a particular visitor will require in order to publish an item. The lead time is usually measured in days, and may typically have a value between 0 and 365. It could however, be more precise, to include both hours and minutes.

To revert to the example given above, a traditional magazine publisher may have a typical lead time of 30 days, whereas a website editor may have a typical lead time of two days.

The application server 3 also stores further details about each visitor—such as, for example, the type of media that the visitor requires, the platform upon which the media is used, the territory of the visitor, and whether or not the visitor is a “non-media” visitor—in this case, the term “media” being used to denote membership or not of the news media profession.

A further parameter for each visitor may include the value “internal”. This indicates whether or not a particular visitor is a member of the organisation that runs the servers 1, 2 and 3—in which case, that visitor may have unrestricted rights to all information in the databases.

At this point, it is convenient to explain how a visitor may obtain access to assets in the database server 2.

Firstly, from the visitor computer 4, the visitor logs onto the web server 1 via the Internet, by submitting an email address (or other alternative user name) and password. If both mail address and password match up, the visitor has access to the database server under the control of application server 3, as will be discussed in further detail below.

If the visitor is a new visitor, an opportunity is given to register by submitting details over the Internet to the web server 1. An administrator via computer 5 then evaluates the submitted information and, if satisfactory, grants confirmation of registration and sends a password to the visitor computer 4.

The web server 1 provides a procedure for forwarding a forgotten password to a visitor upon receipt of the visitor's e-mail address. The visitor also has the facility to change password via the Internet and web server 1

To revert to the situation where a visitor has logged in successfully, the application server 3 firstly checks the lead time of the particular visitor. The server 3 then processes all of the relevant data and, by calculator, provisionally makes available all assets that have not yet reached their release date and are within the visitor's lead time.

For example, if a visitor has a lead time of 14 days and logs into the system on 1 July, the visitor will provisionally see all assets having release dates up to 15 July.

However, to prevent the visitor having to sort through assets that are of no relevance, some further data processing and filtering is done, in dependence upon the stored parameters for the particular visitor. Thus, the visitor will see only assets relevant to the visitor's particular country, media and platform. Of course, any one visitor can have more than one country, media type or platform.

The assets are usually grouped byproduct, for presentation to the visitor.

Thus, a wide range of electronic assets may be made readily available to a wide range of visitors, with only those assets relevant to a particular visitor being accessible. This has a number of distinct advantages.

Firstly the visitor does not have to wade through large amounts of assets that are of no relevance. Secondly, the amount of traffic passing over the system can be significantly reduced, thereby improving efficiency and operating speed of the system, and reducing the likelihood of blockages. Thirdly, single updating procedures at the application server can take place for multiple assets, thereafter being effective for all subsequent visitors.

In further explanation of the system, an illustration is given in FIG. 2 of one example of the assignment of access periods to various assets. It will be appreciated that this is a fairly simple example in the interest of clarity, but the general method of operation will be apparent.

In FIG. 2, two products P1 are each made available in four territories T1 to T4, and each has respective assets A1 to An, each of which has an associated release date D1 to D4.

In further detail, for product P1 and territory 1, there is an associated subset of asset A1, A2, A4 and An, all of which have a release date of D1. For the same product in territory T2, there is an associated subset of assets A2, A4 and A5, each of which have release date of D2. And so on.

Visitors 1, 2 and 3 have respective lead times L1, L2 and L3. As already described above, the differing lead times may represent the differing media types with which the visitors are associated.

Therefore, visitor 1 may have an access to the assets for product Pt for territory T1 for an access period which begins on date D1 minus L1. To relate this to the previous example, if the release date for product P1 in territory T1 is 15 July and the lead time L1 for visitor 1 is 14 days, then the access period for visitor 1 will begin on 1 July.

In this simple example, visitor 1 has access only for territory T1, visitor 2 has access for both territories T1 and T2, and visitor 3 has access for both territories T3 and T4.

Typically, a visitor will be allowed only to access data and download it for the purposes of that particular visitor's publication.

Control of the application server 3 is reserved for administrators, such as is illustrated by the administrator's computer 5.

In this example, the administrator has access to four main utilities—Scheduler, Editor, E-Mailer and Reporter.

The Scheduler utility allows the administrator to update quickly a product release date by a simple operation. Upon amending a release date for a product, the release date for every associated asset is automatically updated, which makes the process very quick and accurate.

The Editor utility is a core utility which allow the administrator to create, edit and delete all products, assets, visitors and all parameters relating thereto—including the asset subsets and release dates of the products and the lead times for the visitors.

The E-Mailer utility allows the administrator to create and send bulk e-mails based upon selected search criteria. For example, search criteria may include country, specific company, specific brand, specific platform, etc. Data accumulated in such a search can be saved as a simple data file to the administrator's local computer so that mailing lists and labels can be printed, or the information incorporated into other programs.

The E-Mailer utility may also send out emails automatically to visitors whose parameters are stored in the system, to notify each respective visitor that a new product and/or collection of assets is now available to the visitor, as the result of the calculation of product release date minus visitor's lead time.

Another example of use of the E-Mailer utility is that, in the event that a particular asset is updated, e-mal notification can be immediately sent to all visitors who have already had access to that asset.

The Reporter utility provides log reports to show activity within the system.

A particularly useful feature of the illustrated system is that, once a product reaches its release date, then all of its respective assets, that are not required for any other product, are archived into an archive area. Archived assets may still be available to visitors on and after the release date. However the archiving step ensures optimum use of the database storage means, and prevents a user from having to sift through details of products that have already passed their release date. When logging onto the system, a visitor may be presented with a list of items that have changed and/or become visible since the last logon.

The illustrated storage and retrieval system may be used by a company to store and retrieve assets relating to its own company products. Alternatively, the system may be used by a bureau to provide a facility for a number of different companies to store and retrieve electronic assets relating to their own products. In the latter case in particular, visitors from the client companies can upload electronic assets to an administrator of the system, for the administrator to add to the overall asset database.

A system as illustrated and described above may have a number of advantages. It may have great potential for companies that release information or products on a regular basis, especially those trading in multiple territories. This can be in the form of information on product launches provided to the media, or information released to departments within the intranets of large multinational corporations.

As the system may be loaded with information for each product and corresponding assets only once, the workload of Public Relations and Sales departments may be greatly reduced and accuracy assured. The demand for physical press pacts is reduced as visitors may visit the website to access information. This reduces costs as both the physical information (e.g. press release and artwork) need not be printed and packages do not need to be put together and posted to clients. Additional costs are reduced if extra material needs to be created, as an Administrator is able to E-mail the respective visitors and let them know of any changes/updates (and where to find them) rather than having to re-release a press pack.

The system is able to target individual countries and territories. This means that an Administrator can rest assured in the knowledge that information will be released to the various countries to coincide with the launch (or lack thereof) of a product in a given country. This can be extended to ensure that different legal angles are covered—countries that reflect different artwork (e.g. logos) will be shown the correct assets and those where the product is not being marketed will not have access to the information. Varying contact information and pricing details can also be covered in this area.

As the system can handle multiple release dates, multiple countries/territories/bulk E-mails, etc., the potential for operator error is reduced.

Each visitor wishing to gain access to the information on the site must be approved by an Administrator and, having gained approval, is provided with an individually allocated and secure password to access the information. This helps an Administrator to gain helpful knowledge of the visitor and to track interest in various products and assets on the system. Through this, an Administrator is able to fine tune a marketing program and, where necessary, target individual visitors to find out why they are not using the system or what they find helpful within it. Highlighting visitor activity on the system allows the focusing of resources on those who are not actively using the system.

The system can provides 24 hour access to information, 365 days a year. This means that visitors can access the information from anywhere and at anytime and are not restricted by time lines or the need to contact responsible individuals.

Automatic transfer of products to the Archive Area after release can ensure that the Release Schedule does not get cluttered when new products are added.

As has been explained above, a particular advantage of systems as illustrated is the facility to provide staggered access periods to assets, to selected visitors. For example, in the context of publishing reviews of a new product, by staggering the access periods to assets so that a magazine editor sees information on the 1st, and a web-based editor on the 29th day of the month, one may ensure that they will publish their reviews at substantially the same time.

Although the illustrated system operates over the Internet, other embodiments of the invention may operate on other network systems.

The web server 1, database server 2 and application server 3 may be provided by one or more dedicated machine. Alternatively, they may be realised by a computer program (which may be stored on a carrier medium), loaded onto one or more general purpose computer.

In this specification, the verb “comprise” has its normal dictionary meaning, to denote non-exclusive inclusion. That is, use of the word “comprise” (or any of its derivatives) to include one feature or more, does not exclude the possibility of also including further features.

The reader's attention is directed to all and any priority documents identified in connection with this application and to all and any papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. storing in a second database a plurality of product parameters for each of a plurality of products;
storing in a third database a plurality of visitor parameters for each of a plurality of visitors; and
controlling retrieval of said assets in dependence upon said parameters:
wherein:
one of said product parameters for each of said products comprises a subset of said electronic assets which is associated with the product;
another of said product parameters for each of said products comprises a release date;
one of said visitor parameters for each of said visitors comprises a lead time; and
said controller permits retrieval of said assets by a visitor over a real time period that commences upon a date that is equal to said release date of one of said products minus said lead time of the visitor.

3. A system according to claim 1, wherein said first, second and third databases are located in a common memory device.

4. A system according to claim 1, wherein archive means is provided which is arranged to archive each of said assets after the release date of the or each said product with which it is associated has passed.

5. A system according to claim 1, wherein a network server is provided that is arranged to provide access to said assets to visitors over a network.

6. A system according to claim 5, wherein said network is a global computer network.

7. A system according to claim 1, wherein at least one of said electronic assets is selected from images, documents, video streams and audio data.

8. A system according to claim 1, wherein one of said product parameters comprises territory.

9. A system according to claim 1, wherein at least one of said visitor parameters is selected from territory, media type and operating platform.

10. A system according to claim 1, wherein update means is provided and is arranged to update a common parameter of a plurality of said assets upon updating a like parameter for one of said products with which said assets are associated.

11. A computer program on a carrier and adapted to perform a method according to claim 2.

12. A computer when programmed to perform a method according to claim 2.

14. A method according to claim 2, wherein archive means is provided which is arranged to archive each of said assets after the release date of the or each said product with which it is associated has passed.

15. A method according to claim 2, wherein a network server is provided that is arranged to provide access to said assets to visitors over a network.

16. A method according to claim 17, wherein said network is a global computer network.

17. A method according to claim 2, wherein at least one of said electronic assets is selected from images, documents, video streams and audio data.

18. A method according to claim 2, wherein one of said product parameters comprises territory.

19. A method according to claim 2, wherein at least one of said visitor parameters is selected from territory, media type and operating platform.

20. A method according to claim 2, wherein update means is provided and is arranged to update a common parameter of a plurality of said assets upon updating a like parameter for one of said products with which said assets are associated.
